(19) United States
(12) Patent Application Publication
(10) Pub. No.: US 2026/0146007 A1
(43) Pub. Date: May 28, 2026

(54) ADVANCED POLYMER IMPREGNATION AND PYROLYSIS OF CERAMIC MATRIX COMPOSITES

(71) Applicant: UT-Battelle, LLC, Oak Ridge, TN (US)

(72) Inventors: Corson L. Cramer, Knoxville, TN (US); Steven E. Bullock, Knoxville, TN (US); David Mitchell, Farragut, TN (US); Jordan Wright, Oak Ridge, TN (US); John Stuecker, Albuquerque, NM (US); Hunter B. Berner, Albuquerque, NM (US)

(21) Appl. No.: 19/398,245

(22) Filed: Nov. 24, 2025

Related U.S. Application Data
(60) Provisional application No. 63/724,440, filed on Nov. 25, 2024.

(51) Int. Cl. C04B 35/80; C04B 35/626; C04B 35/628; C04B 35/645

(52) U.S. Cl. CPC C04B 35/80; C04B 35/6267; C04B 35/6269; C04B 35/62886; C04B 35/62894; C04B 35/645; C04B 2235/3826; C04B 2235/386; C04B 2235/3873; C04B 2235/483; C04B 2235/5244; C04B 2235/5248; C04B 2235/5252; C04B 2235/616; C04B 2235/656

(57) ABSTRACT

A method of manufacturing a ceramic composite includes: prepregging a plurality of porous fiber cloths, a powder compact, a combination thereof, or additively-manufactured matrix and fibers, with a preceramic polymer composition to form a preform composite body; curing the composite body followed by pyrolyzing the cured composite body to obtain a ceramic composite body; densifying the ceramic composite body by sequentially performing a plurality of densification cycles to obtain a densified ceramic composite body, wherein each densification cycle includes: submerging the ceramic composite body in the preceramic polymer composition to impregnate the ceramic composite body; subjecting the impregnated ceramic composite body to a vacuum; curing the impregnated composite body; and pyrolyzing the impregnated composite body; and subsequently crystallizing the densified ceramic composite body. The preceramic polymer composition comprises a preceramic polymer component, a crosslinker, and a catalyst.

### CROSS-REFERENCE TO RELATED APPLICATIONS

This application claims the benefit of U.S. Provisional Application No. 63/724,440, filed Nov. 25, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of manufacturing ceramic composite materials.

### BACKGROUND OF THE INVENTION

Silicone carbide (SiC) ceramic matrix composites (CMCs) are a class of advanced materials highly sought after for their exceptional combination of high strength, high thermal stability, low density, low thermal conductivity, chemical inertness, and toughness and damage tolerance. This unique blend of properties makes these ceramic matrix composites ideal candidates for various harsh environment applications, including hypersonics, gas turbines, nuclear reactors, and heat exchangers. However, unlocking the full potential of ceramic matrix composites hinges on achieving high matrix density during the manufacturing process while maintaining interfaces and bonding of matrix to fibers to provide enough strength with high toughness or strain to failure. Typically, silicon carbide ceramic matrix composites consist of high-quality and crystalline SiC fibers made from preceramic polymers, a porous or lubricious interface coating, and a high-density, strong matrix.

Silicon carbide ceramic matrix composites are densified through various methods, including chemical vapor infiltration (CVI), reaction melt infiltration (RMI), and polymer impregnation and pyrolysis (PIP). Chemical vapor infiltration is a widely adopted technique that involves infiltrating composites with gaseous precursors to create a highly crystalline and pure SiC matrix. However, surface sealing and premature pore blockage during chemical vapor infiltration can lead to composites with high porosity (˜20%). Furthermore, achieving uniform densification requires slow deposition rates leading to long processing times (>100 hrs) and thus high-cost silicon carbide composites. Alternatively, reaction melt infiltration is a quick and effective means of densifying silicon carbide ceramic matrix composites and reducing porosity. However, the chemical reaction between carbon and silicon to form SiC during reaction melt infiltration can damage fibers and fiber-matrix interface coatings and can result in unreacted residual silicon metal that can degrade mechanical properties such as accelerating creep.

Polymer impregnation and pyrolysis presents a simple approach to densifying silicon carbide ceramic matrix composites. Polymer impregnation and pyrolysis involves infiltrating fiber preforms with a preceramic polymer (PCP), followed by pyrolysis to convert the preceramic polymer to an amorphous SiC or SiOC matrix, which is also followed by heat treatments to crystallize the matrix material into crystalline SiC, SiO₂, and carbon. However, the polymer impregnation and pyrolysis process suffers from the same drawback as chemical vapor infiltration in that it produces porous composites when the part thickness is large. For example, since polymer impregnation and pyrolysis produces gaseous byproducts during pyrolysis, voids are produced in the matrix of the composites. Thus, a multitude of PIP cycles are often required to achieve high densification, thereby increasing the cost of the process.

### SUMMARY OF THE INVENTION

A method of manufacturing a ceramic composite is provided. The method includes the step of prepregging a plurality of porous fiber cloths, a powder compact, a combination of porous fiber cloths and powder compact, or an additively-manufactured matrix and fibers, with a preceramic polymer composition to form a preform composite body. The method further includes the step of curing the composite body followed by pyrolyzing the cured composite body to obtain a ceramic composite body. The method further includes the step of densifying the ceramic composite body by sequentially performing a plurality of densification cycles to obtain a densified ceramic composite body, wherein each densification cycle includes in the following order: submerging the ceramic composite body in the preceramic polymer composition to impregnate the ceramic composite body; subjecting the impregnated ceramic composite body to a vacuum; curing the impregnated composite body at a curing temperature; and pyrolyzing the impregnated composite body at a pyrolyzing temperature. The preceramic polymer composition comprises a preceramic polymer component, a crosslinker, and a catalyst. The method further includes the step of crystallizing the densified ceramic composite body at a crystallization temperature to obtain a ceramic matrix composite product.

In specific embodiments, each densification cycle further includes subjecting the impregnated ceramic composite body to pressure while submerging the ceramic composite body in the preceramic polymer composition.

In specific embodiments, the preceramic polymer component is one of: i) a polycarbosiloxane; ii) a polysiloxane; iii) a polysilazane; iv) a carbosilane; or v) a combination of two or more of i) through iv).

In specific embodiments, the catalyst is a Pt, Sn, Mo, Ti, or Bi-based catalyst.

In specific embodiments, the crosslinker is a backbone material having functional groups for addition and/or condensation cure reactions, the backbone material including silicon and oxygen and/or carbon.

In specific embodiments, the fiber cloths or powder compacts are a carbon-based material or a ceramic material.

In particular embodiments, the fiber cloths are coated with one or more of boron nitride, boron carbonitride, silicon nitride, and pyrolytic carbon (PyC).

In specific embodiments, the composite body is formed by laminating the plurality of prepreg fiber plies.

In specific embodiments, in the step of prepregging the plurality of fiber cloths or powder compact, the preceramic polymer composition further comprises silicon carbide (SiC) powder.

In specific embodiments, the step of densifying the ceramic composite body includes: i) at least five of the densification cycles; ii) from six to ten of the densification cycles; or iii) no more than seven of the densification cycles.

In specific embodiments, the ceramic matrix composite product has a matrix including one or more of carbon (C), silicon oxycarbide (SiOC), silicon carbide (SIC), and silicon dioxide (SiO₂), silicon carbonitride (SiCN), silicon oxynitride (SiON), trisilicon tetranitride (Si₃N₄), and boron carbide (B₄C).

In specific embodiments, the curing temperature is in a range of from 150 to 300° C.

In specific embodiments, the pyrolyzing temperature is in a range of from 700 to 1000° C.

In specific embodiments, the crystallization temperature is in a range of from 1000 to 1700° C.

A ceramic matrix composite formed by the method is also provided.

These and other features of the invention will be more fully understood and appreciated by reference to the description of the embodiments and the drawings.

### BRIEF DESCRIPTION OF THE DRAWINGS

FIG. 1 is a flowchart of a method of making a ceramic composite in accordance with embodiments of the disclosure;

FIG. 2 is a graph of a thermogravimetric analysis (TGA) of neat polycarbosiloxane (PCS) resin and crosslinked PCS resin;

FIG. 3 is a graph of a Raman analysis of neat PCS resin and crosslinked PCS resin;

FIG. 4 is a graph of a flow sweep test of neat PCS resin and crosslinked PCS resin;

FIG. 5 is a graph of storage and loss moduli as a function of time illustrating rheological behavior of neat PCS resin and crosslinked PCS resin;

FIG. 6 is a graph of oscillation stress as a function of time illustrating rheological behavior of neat PCS resin and crosslinked PCS resin;

FIG. 7 is a graph of geometric density as a function of successive polymer impregnation and pyrolysis (PIP) cycles for ceramic matrix composites made in accordance with embodiments of the disclosure and in accordance with the prior art;

FIG. 8 is a graph of Archimedes bulk density and apparent porosity after crystallization for ceramic matrix composites made in accordance with embodiments of the disclosure and in accordance with the prior art;

FIG. 9 is another graph of geometric density as a function of successive PIP cycles for ceramic matrix composites made in accordance with embodiments of the disclosure and in accordance with the prior art;

FIG. 10 is another graph of Archimedes bulk density and apparent porosity after crystallization for ceramic matrix composites made in accordance with embodiments of the disclosure and in accordance with the prior art;

FIG. 11 is a graph of density as a function of successive PIP cycles for ceramic matrix composites made in accordance with embodiments of the disclosure and in accordance with the prior art;

FIG. 12 is a graph of porosity as a function of successive PIP cycles for ceramic matrix composites made in accordance with embodiments of the disclosure and in accordance with the prior art;

FIG. 13 is a graph of force-displacement curves of ceramic matrix composites made in accordance with embodiments of the disclosure;

FIG. 14 is a graph of thermal diffusivity and specific heat of ceramic matrix composites made in accordance with embodiments of the disclosure;

FIG. 15 is a graph of thermal conductivity of ceramic matrix composites made in accordance with embodiments of the disclosure;

FIG. 16 is another graph of geometric density as a function of successive PIP cycles for ceramic matrix composites made in accordance with embodiments of the disclosure and in accordance with the prior art;

FIG. 17 is another graph of Archimedes bulk density and apparent porosity after crystallization for ceramic matrix composites made in accordance with embodiments of the disclosure and in accordance with the prior art; and

FIG. 18 is another graph of force-displacement curves of ceramic matrix composites made in accordance with embodiments of the disclosure.

### DETAILED DESCRIPTION OF THE CURRENT EMBODIMENTS

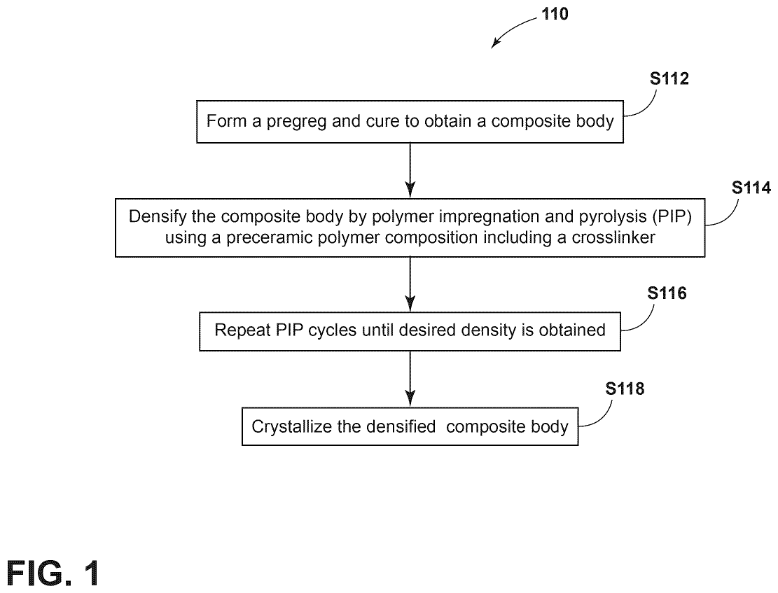

As discussed herein, the current embodiments relate to a method 110 for manufacturing a ceramic composite. As generally illustrated in FIG. 1, the method includes forming a prepreg and curing the prepreg to obtain a composite body, densifying the composite body by polymer impregnation and pyrolysis (PIP) to obtain a densified composite body, and crystallizing the densified composite body. Each step is separately discussed below.

The method 110 first includes at step S112 forming and curing a prepreg to obtain a composite body. In some embodiments, step S112 includes prepregging a plurality of porous fiber cloths. The fiber cloths may be made from a carbon-based material or a ceramic material, such as, for example a carbon fiber cloth or a silicon carbide-type fiber cloth. In certain embodiments, the fiber cloths are coated with boron nitride, boron carbonitride, silicon nitride, pyrolytic carbon (PyC), or any combination thereof. Each fiber cloth is pre-impregnated with a preceramic polymer composition to form a plurality of prepreg fiber plies. The composite body is formed by laminating a plurality of the prepreg fiber plies, such as, for example, between 10 and 20 layers. The composite body is then cured at one temperature, for example between 15° and 300° C., for a period of time, followed by pyrolyzing the cured composite body at a second, higher temperature, for example between 70° and 1000° C., for another period of time. Curing of the composite body may include placing the composite body in a mold. In other embodiments, step S112 includes prepregging a powder compact by pre-impregnating a powder layer with the preceramic polymer composition and forming the composite body from a plurality prepreg powder layers, followed by curing and pyrolyzing the composite body. The powder compact may also be formed from a carbon-based material or a ceramic material such as a silicon carbide powder. In other embodiments, the prepreg is formed from a combination of fiber cloth and powder compact. In yet other embodiments, the prepreg is formed of an additively-manufactured matrix and fibers. The fibers may be continuous fibers, chopped fibers, or fiber whiskers. In the various embodiments, the prepreg preform may therefore be formed by molding, pressing, and/or 3D printing/additive manufacturing.

In various embodiments, the preceramic polymer composition includes a preceramic polymer component, a crosslinker, and a catalyst. The preceramic polymer component may be a polycarbosiloxane, a polysiloxane, a polysilazane, a carbosilane, or any combination thereof. The catalyst may be, for example, a Pt, Sn, Mo, Ti, or Bi-based catalyst that is capable of catalyzing an addition and/or condensation cure reaction. The crosslinker is not particularly limited and may be a backbone material including one or more of silicon, oxygen, and/or carbon and having one or more functional groups that are capable of addition or condensation cure reactions. As such, the crosslinker may be a silicon and oxygen and/or silicon-carbon backbone material. In some embodiments, silicon carbide (SiC) powder is included in the preceramic polymer composition.

The method 110 next includes at step S114 densifying the ceramic composite body by sequentially performing a plurality of densification cycles to obtain a densified ceramic composite body. The densification is specifically a polymer impregnation and pyrolysis (PIP) process that uses the preceramic polymer composition described above. Each PIP densification cycle includes in the following order: submerging the ceramic composite body in the preceramic polymer composition to impregnate the ceramic composite body; subjecting the impregnated ceramic composite body to a vacuum for a period of time; curing the impregnated composite body at a curing temperature for another period of time; and pyrolyzing the impregnated composite body at a pyrolyzing temperature for yet another period of time. In various embodiments, the curing temperature is in a range of from, but not limited to, 150 to 300° C. The pyrolyzing temperature is in a range of from, but not limited to, 700 to 1000° C. The crystallization temperature is in a range of from, but not limited to, 1000 to 1700° C. The time period for the vacuum sub-step is not particularly limited, but may be, by way of example only, in a range of from 10 to 30 minutes. The time period for the curing sub-step is not particularly limited, but may be, by way of example only, in a range of from 1 to 3 hours. The time period for the pyrolyzing sub-step is not particularly limited, but may be, by way of example only, in a range of from 1 to 3 hours. In specific embodiments, each PIP densification cycle also includes subjecting the impregnated ceramic composite body to pressure (e.g., above atmospheric pressure) while submerging the ceramic composite body in the preceramic polymer composition while the preceramic polymer composition is a liquid, such as, for example, by using a pressure vessel. In other specific embodiments, the concentration of the preceramic polymer composition may be increased in successive PIP cycles.

In various embodiments, at step S116 the method 110 includes performing at least five of the PIP densification cycles described above; however, it should be understood that the method may include only three or four of the PIP densification cycles. In some embodiments, the method 110 includes performing from six to fifteen of the PIP densification cycles, optionally from six to thirteen of the PIP densification cycles, optionally from six to twelve of the PIP densification cycles, optionally from six to ten of the PIP densification cycles, optionally from six to eight of the PIP densification cycles optionally from six to ten of the PIP densification cycles. In yet other embodiments, the method 110 includes performing from five to fifteen of the PIP densification cycles, optionally from five to thirteen of the PIP densification cycles, optionally from five to twelve of the PIP densification cycles, optionally from five to ten of the PIP densification cycles, optionally from five to eight of the PIP densification cycles, optionally from five to seven of the PIP densification cycles, optionally from five to six of the PIP densification cycles, optionally from six to seven of the PIP densification cycles. In certain embodiments, the method 110 includes performing no more than seven of the PIP densification cycles.

After the PIP densification of the ceramic composite body using the preceramic polymer composition to obtain the densified ceramic composite body, the method finally includes at step S118 crystallizing the densified ceramic composite body at a crystallization temperature for a period of time to obtain a ceramic matrix composite product. In various embodiments, the crystallization temperature is in a range of from, but not limited to, 1000 to 1700° C. The time period for the crystallization step is not particularly limited, but may be, by way of example only, in a range of from 3 to 5 hours. The resulting ceramic matrix composite product may have a matrix including one or more of carbon (C), silicon oxycarbide (SiOC), silicon carbide (SIC), and silicon dioxide (SiO₂), silicon carbonitride (SiCN), silicon oxynitride (SiON), trisilicon tetranitride (Si₃N₄), and boron carbide (B₄C).

In summary, the method 110 includes forming and curing a prepreg with a preceramic polymer composition, and subsequently densifying the ceramic composite body by a plurality of PIP cycles using the preceramic polymer composition. The method 110 advantageously provides for sufficient and effective densification of the ceramic composite body in as a few as five to six PIP cycles using the preceramic polymer composition. The method 110 achieves this densification at far fewer PIP cycles than typically required to achieve the same densification.

### EXAMPLES

The present method is further described in connection with the following laboratory examples, which are intended to be non-limiting.

The effects of two polycarbosiloxane (PCS) resins on densification of fiber cloth layered ceramic matrix composites was examined. The first resin was a neat PCS, which served as the control and was used in conventional PIP (C-PIP). The second was a modified PCS that incorporated a blend of a preceramic polymer, a crosslinker, and a Pt-based catalyst. This crosslinked PCS was used during advanced PIP (A-PIP) in accordance with embodiments of the disclosure herein.

A total of five ceramic matrix composites were created to evaluate the effectiveness of A-PIP: two C—SiC composites and three SiC—SiC ceramic matrix composites. The C—SiC composites comprised thirteen 130 mm×130 mm plies of desized AS4 carbon fiber cloth, while the SiC—SiC composites comprised seventeen 130 mm×130 mm plies of Hi-Nicalon™ Type S fiber cloth obtained from COIC Ceramics, Inc, San Diego, CA. Of the three SiC—SiC composites, two were fabricated with desized SiC fibers while the other incorporated boron nitride chemical vapor deposition (BN CVD)-coated fibers. The BN CVD coating was a PSI MOD-1 coating consisting of 250 nm of BN and 125 nm of silicon nitride (SN). For all ceramic matrix composites, fiber plies were prepregged with a PCS resin and laid up onto a metal plate in alternating 0° and 90° orientations. The PCS resin varied amongst the ceramic matrix composites as shown in Table 1 below. Cf-NC-C and SiCf-NC-C were prepregged with neat PCS since they were densified via C-PIP, whereas Cf-NC-A, SiCf-NC-A, and SiCf-BN-A were prepregged with the crosslinked resin since they were densified via A-PIP.

TABLE 1
Composition and densification method
for each SiC-matrix composite

| | | Fiber | # of | | PIP |
|---|---|---|---|---|---|
| Sample ID | Fiber Type | Coating | Plies | Prepreg Resin | Method |
| Cf-NC-C | AS4 | None | 13 | Neat PCS | C-PIP |
| Cf-NC-A | AS4 | None | 13 | Crosslinked | A-PIP |
| | | | | PCS | |
| SiCf-NC-C | Hi-Nicalon ™ | None | 13 | Neat PCS | C-PIP |
| SiCf-NC-A | Hi-Nicalon ™ | None | 17 | Crosslinked | A-PIP |
| | | | | PCS | |
| SiCf-BN-A | Hi-Nicalon ™ | BN | 17 | Crosslinked | A-PIP |
| | | | | PCS | |

After ply layup, all ceramic matrix composites, except for SiCf-NC-C, were infiltrated and cured in a vacuum bag for 3 hours at 200° C. When attempting to vacuum bag SiCf-NC-C, the plies would not stick together. To solve this problem, a metal block was placed on the stacked prepregs to keep the plies stuck together during curing. Next, each ceramic matrix composite was pyrolyzed at 900° C. for 30 minutes in argon gas before undergoing at least 6 cycles of either C-PIP or A-PIP. Both PIP methods involve submerging a composite in PCS resin and applying vacuum for 20 minutes in a desiccator with a Vacuubrand ME-2C-NT pump (rated at 70 mbar), followed by curing at 240° C. for 2 hours in air. Afterward, the cured ceramic matrix composite was pyrolyzed and the PIP cycle was repeated. After a ceramic matrix composite underwent its last PIP cycle, it was crystalized at 1300° C. for 4 hours in argon. The geometric density of each ceramic matrix composite was monitored after each pyrolysis step to compare the densification effectiveness of A-PIP and C-PIP.

Another SiC—SiC ceramic matrix composite was fabricated to illustrate the effect of powder loading on densification. This CMC (SiC—BN-A+) was fabricated with 13 plies of BN-coated SiC fibers and densified with A-PIP. Unlike the other ceramic matrix composites, the plies were prepregged with the crosslinked resin being loaded with 10 vol % SiC powder in an attempt to increase the initial density of the SiC—SiC ceramic matrix composite and to improve densification.

Thermogravimetric analysis (TGA) and rheometry were used to characterize the PCS resins. TGA measurements of ceramic yield were performed using a TGA 5500 (TA Instruments). Samples of the PCS resins (cured at 240° C.) measuring 20-25 mg were evaluated to 1000° C. at 3° C./min under argon. Two TGA runs were performed for each resin. Raman spectra of crystallized neat and crosslinked PCS were acquired using a Raman microprobe (InVia) with a 532 nm Nd-YAG laser. The spot size was approximately 20 μm.

The rheological properties of neat and crosslinked PCS resins were measured using an ARES-G2 (TA Instruments) rheometer. The first test was a flow sweep test, where each resin was loaded into a cup and bob fixture due to their low viscosity. The gap size was set to 0.5 mm, and the resins were presheared at 0.01 s⁻¹ for 2 minutes, followed by a 2-minute equilibration period. Continuous flow sweeps were conducted at shear rates ranging from 5 to 100 s⁻¹, with five measurements taken per decade. The second test was an oscillation time sweep and it measured the gelation time of each resin. The resins were loaded between two 25 mm parallel plates with a 0.5 mm gap size. The resins were presheared using the same procedure used for the flow sweep test. The oscillation time sweep was run for 4 hours at a constant frequency of 5 Hz, with measurements taken every minute. Each test was performed twice.

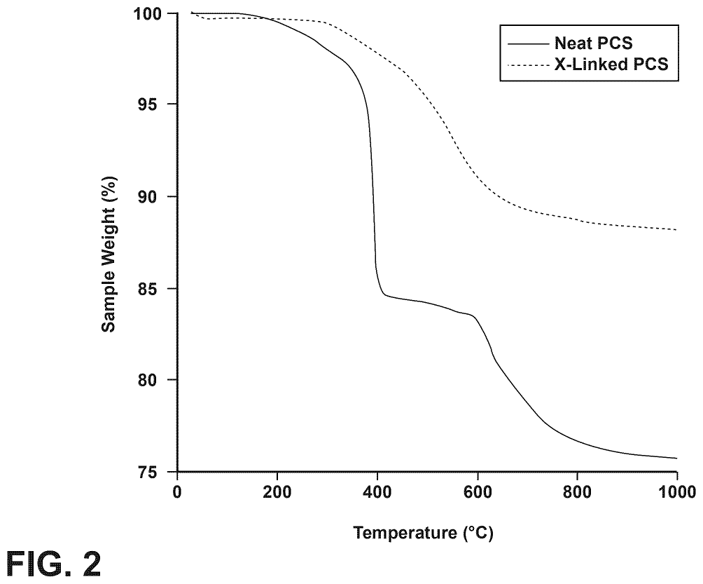

FIG. 2 shows the TGA results comparing ceramic matrix composites made with neat PCS resin to ceramic matrix composites made with crosslinked (X-linked) PCS resin. The neat PCS resin (conventional) samples lost a significant amount of mass from 360° C. to 430° C. (12%). The samples continued to lose mass but more gradually beyond 600° C., resulting in a mass yield of 76%. In contrast, the crosslinked PCS resin samples (current embodiments) experienced a more gradual mass loss between 300° C. and 700° C., leading to an improved mass yield of 88%. This improvement in yield may be attributed to the increased molecular weight of the PCS resin after the addition of the crosslinker and catalyst, which stabilized the polymer network during the pyrolysis process and minimized mass loss.

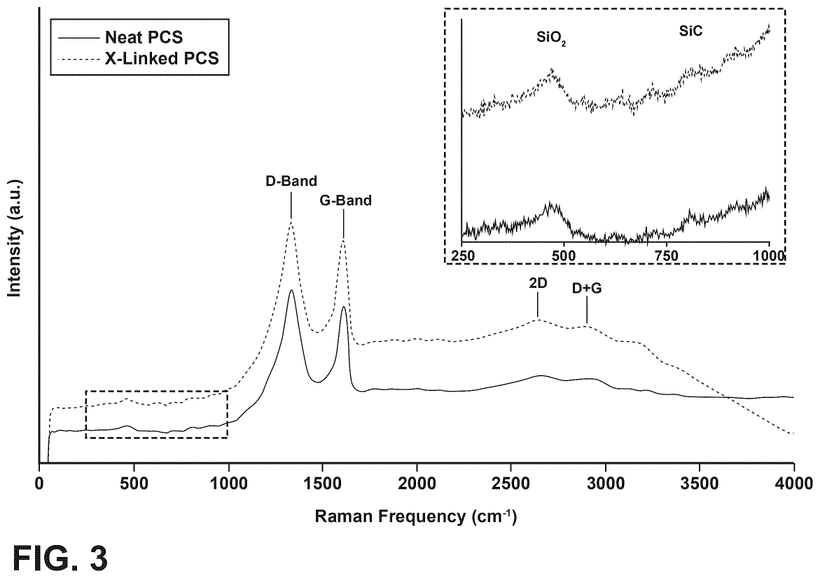

Raman analysis results of crystallized neat and crosslinked PCS resin shown in FIG. 3 illustrated that the addition of the crosslinker and catalyst did not alter the composition of the PCS after crystallization. Both neat and crosslinked PCS resins produced some silicon carbide (SiC) after crystallization, as shown by the band at ˜800 cm⁻¹. A broad band at ˜470 cm⁻¹ was observed in each sample, indicating the presence of amourphous silica (SiO₂). In addition, the D, G, and 2D bands observed at ˜1350, ˜1580, and ˜2700 cm⁻¹, respectively, correspond to bands seen in SiOC. The formation of SiO₂ and SiOC suggested that the oxygen in the backbone of the PCS was retained during the crystallization process.

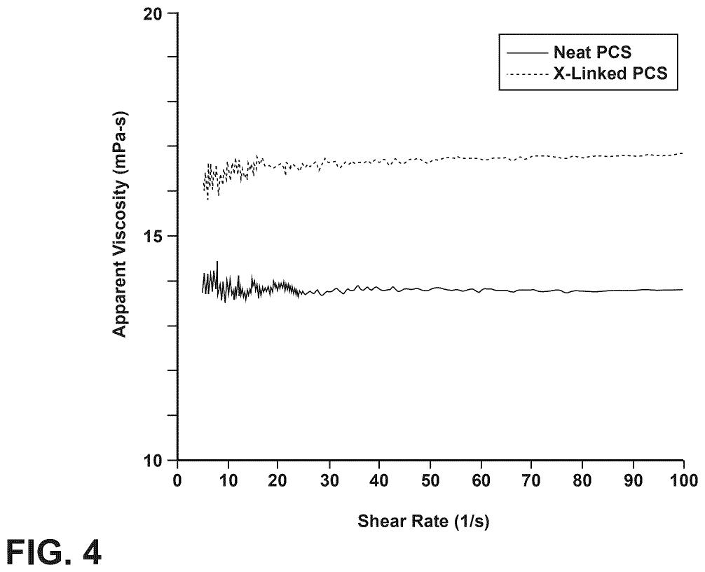

The results of the flow sweep test shown in FIG. 4 revealed that the neat PCS (conventional) resin behaved as a Newtonian fluid, with a constant viscosity of 13.8 mPa·s across all shear rates. The viscosity of the neat PCS is comparable to that of water (˜10 mPa·s), indicating that the neat PCS was well-suited for effective PIP densification, as it can easily permeate and fill the open porosities of a ceramic matrix composite. Crosslinking the PCS resin according to current embodiments did not immediately affect its rheological behavior. The crosslinked resin maintained its Newtonian characteristics but with a slightly higher viscosity of 16.5 mPa·s. This indicated that crosslinking the resin enhanced ceramic yield without immediately affecting its viscosity, allowing for efficient infiltration while retaining more of its mass through pyrolysis compared to neat resin.

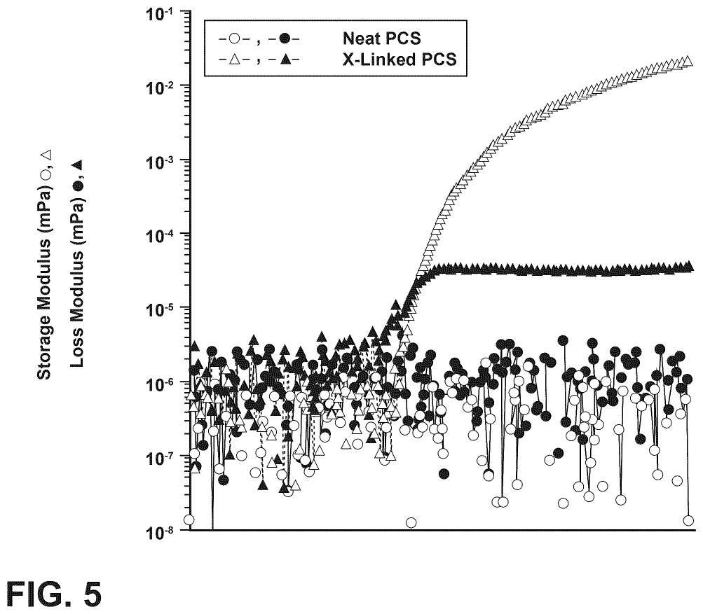

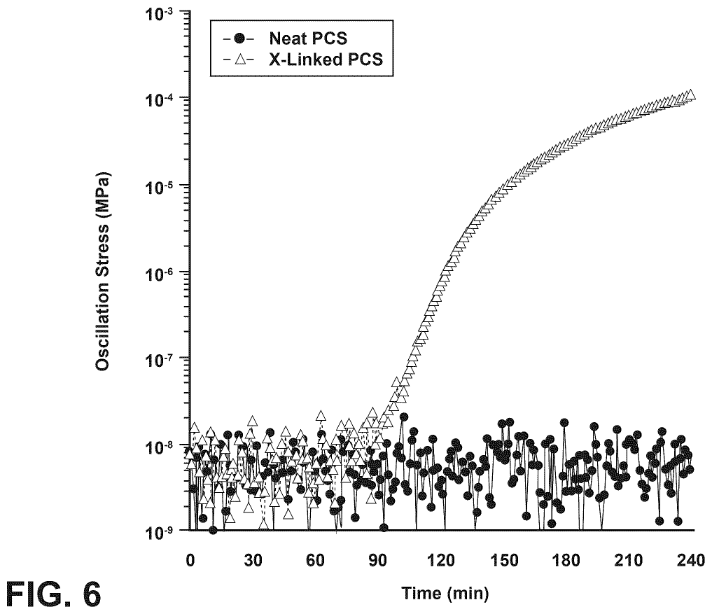

The difference in rheological behavior between neat and crosslinked PCS resins became evident in the oscillation time sweep tests. As shown in FIG. 5, the neat PCS resin remained a liquid throughout the test, with the storage modulus consistently higher than the loss modulus. Despite some noise in the data, the oscillation stress-time data shown in FIG. 6 confirmed this behavior, as the oscillation stress remained stable between 10⁻⁹ and 10⁻⁸ MPa, indicating no significant change in the resin's rheology. These results confirm that neat PCS resin can maintain its liquid state when stored properly, making it reusable for multiple PIP cycles. In contrast, adding a crosslinker and catalyst to the PCS resin led to significant changes over time. For the first 90 minutes, the crosslinked PCS resin behaved like a liquid similarly to the neat resin, with the storage modulus higher than the loss modulus and the oscillation stress remaining constant (10⁻⁹ to 10⁻⁸ MPa). After 90 minutes, both the storage and loss moduli began to increase, which was accompanied by a rise in oscillation stress, indicating the start of the crosslinking reaction. At the 110-minute mark, the loss modulus was equivalent to the storage modulus, indicating that the resin had transitioned from a liquid to a gel. After this point, the loss modulus continued to rise, while the storage modulus remained steady at 3.1×10⁻⁵ MPa, signifying that the crosslinked PCS resin had fully cured and was now in a solid state. These findings highlight the trade-off between the two resins. Neat PCS resin can be stored and reused across multiple PIP cycles but offers lower mass yield. On the other hand, crosslinked PCS resin improves yield but has a limited working time and cannot be reused once it has cured.

The morphologies and elemental distributions of the CVD coating of the SiC fibers were analyzed by scanning transmission electron microscopy (STEM). High-resolution STEM imaging and energy-dispersive X-ray spectroscopy (EDS) analysis were performed on an aberration-corrected JEOL JEM-ARM200F NEOARM TEM/STEM operated at 200 kV with a cold field emission gun (Cold-FEG), and EDS system with dual JEOL 100 mm² silicon-drift detectors (SDD) for chemical analysis. High-resolution analysis was performed with a nominal beam current of ˜25 pA and associated resolution of a nominal 0.7 Å. TEM lamella were prepared via the focus ion beam (FIB) in situ lift-out technique using a Hitachi NB5000 FIB-SEM.

SEM images of the coated SiC fibers revealed that all fibers were successfully coated with the PSI MOD-1 coating. EELS analysis confirmed the composition of the coating. The SiC fiber was coated with approximately 1 μm of BN and 0.65 μm of silicon nitride (SiN), which was thicker than the expected 250 nm and 125 nm, respectively. However, the thicker coating was still expected to improve ceramic matrix composite properties. Oxygen was detected at the fiber-coating interface, indicating the presence of SiO₂. The formation of a nano-scale oxide layer on the surface of SiC fiber was not unexpected, given SiC's tendency to oxidize. Nevertheless, the SiO₂ layer was less than a nanometer thick, and thus unlikely to have any adverse effects on the SiCf-SiC ceramic matrix composites. EELS also verified that the BN coating was primarily composed of hexagonal BN (h-BN) with some cubic BN. Therefore, the coated SiC fibers should be significantly tougher and stronger than those with uncoated fibers.

The bulk density (BD) and apparent porosity (AP) of each ceramic matrix composite was calculated following the ASTM C830 standard (i.e. Archimedes principle). Five 35 mm×6 mm×3 mm samples were analyzed per ceramic matrix composite, and the analysis was performed on an OHAUS Explorer™. The BD and AP were calculated using Equations 1 and 2, respectively:

$$B D = ρ \frac{{m}_{d r y}}{{m}_{s a t} - {m}_{s u s}} \qquad ( 1 )$$

$$AP = ρ \frac{{m}_{s a t} - {m}_{d r y}}{{m}_{s a t} - {m}_{s u s}} \qquad ( 2 )$$

where ρ is the density of ethanol (0.789 g/cc at 20° C.), m_{dry} is the dry mass, mₛₐₜ is the saturation mass, and mₛᵤₛ is the suspended mass. The BD and AP of five samples were calculated for each ceramic matrix composite to assess the variation in the results.

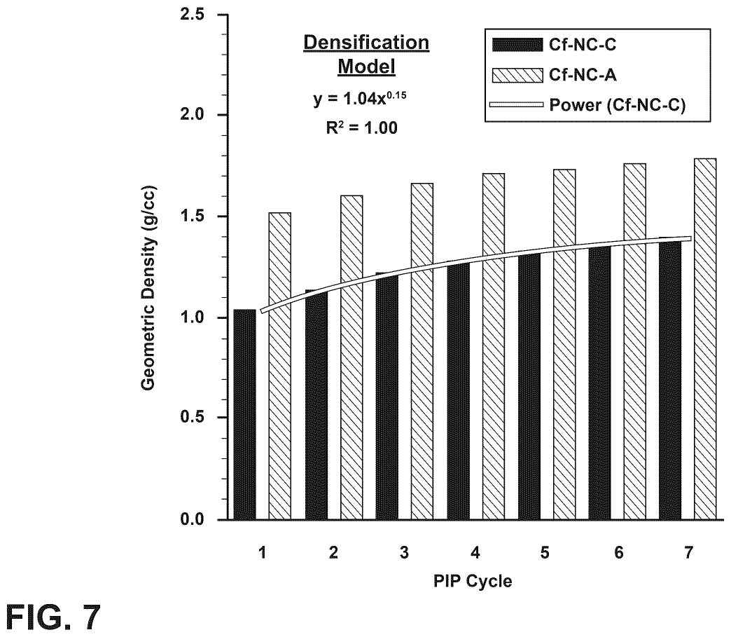

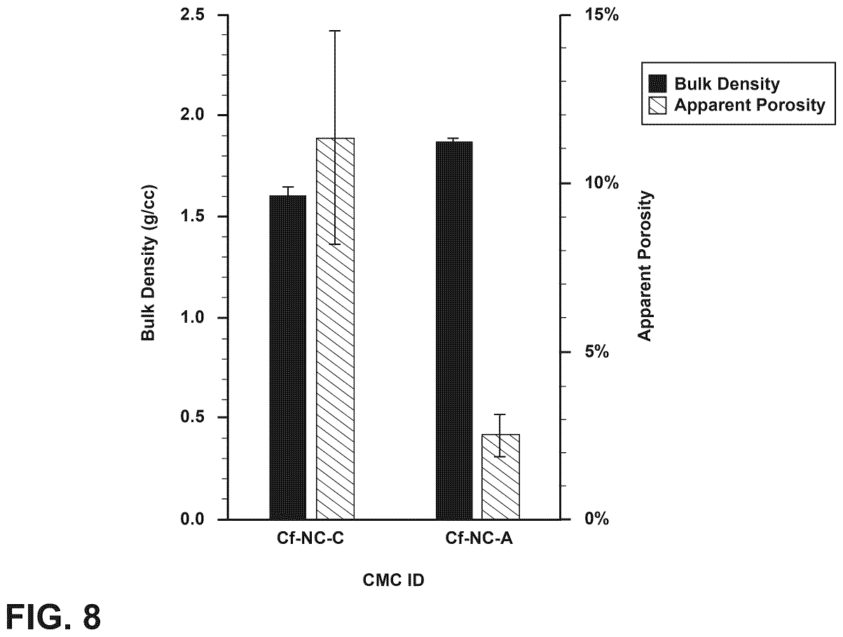

FIG. 7 shows the geometric density changes in the C—SiC composites after successive PIP cycles. Cf-NC-A densified significantly faster than Cf-NC-C. Cf-NC-A had a geometric density 43% and 27% higher than Cf-NC-C after the first and seventh PIP cycles, respectively. This was attributed to the increased mass yield from crosslinking the PCS resin. To quantify the efficiency of A-PIP according to the current embodiments, a power curve was used to model the densification of Cf-NC-C. This model assumed that a ceramic matrix composite's density increases gradually before it levels off with successive PIP cycles, as seen in previous studies. According to the model, Cf-NC-C would require an additional 27 C-PIP cycles, totaling 34 cycles, to reach the same geometric density that Cf-NC-A achieved in just 7 cycles. Thus, A-PIP reduced the number densification cycles by 79%. Archimedes density results confirmed that Cf-NC-A was denser than Cf-NC-C after crystallization as shown in FIG. 8. Cf-NC-A had a bulk density of 1.8 g/cc, while the bulk density of Cf-NC-C was only 1.6 g/cc (19% lower). Additionally, Cf-NC-A was significantly less porous, with 2.5% porosity, compared to the porosity of Cf-NC-C which was 11.4%. Overall, the current embodiments of A-PIP produced C—SiC composites that were 17% denser and 78% less porosity, in 79% less cycles, than those processed with conventional C-PIP.

Samples measuring 13 mm×7 mm×2 mm were machined for microstructural imaging and analysis. These samples were cold mounted into 1.25 inch pucks using Buehler EpoxiCur 2 resin. The mounts were then polished, and mosaic images were captured using a Leica DMI5000 M microscope at 100× magnification. The image analysis software FIJI was employed to process each mosaic image and isolate the matrix material from the fibers and porosities with the Threshold tool. Elemental characterization was conducted on these samples using energy-dispersive X-ray spectroscopy with a EDAX Octane Elect Super Silicon Drift Detector. An accelerating voltage of 20 kV and a 70 nm spot size were used.

Imaging of material cross-sections highlighted the differences between C-PIP and A-PIP. In the microstructure of Cf-NC-C, large matrix voids were observed between the fiber tows due to the low mass yield of C-PIP. In contrast, Cf-NC-A only had small, periodic cracks from matrix shrinkage (a typical feature in PIP-based ceramic matrix composites) and minimal matrix voids. These results support the Archimedes density measurements, demonstrating that A-PIP produced a denser and less porous composite with fewer PIP cycles than C-PIP.

SEM images further illustrated the impact of PIP efficiency on a ceramic matrix composite's microstructure. Large matrix voids and numerous shrinkage cracks were clearly visible in Cf-NC-C. These defects highlighted C-PIP's inefficiency. The vertical cracks followed the fiber-matrix interface and were prominent in the matrix, but no cracks were observed through the fibers. Aside from the matrix voids between the fibers, no gaps were observed at the fiber-matrix interface, indicating strong chemical bonding due to the lack of fiber coating. In contrast, Cf-NC-A exhibited minimal matrix voids and fewer shrinkage cracks due to A-PIP's superior efficiency. A large portion of the shrinkage cracks between fiber tows were refilled during densification, which was not observed in Cf-NC-C. Like Cf-NC-C, the cracks in Cf-NC-A did not propagate into the fibers. In addition, the lack of fiber coating led to strong chemical bonding between the fibers and matrix, as evidenced by the lack of gaps around the fiber interfaces. Microcracks initiated at the fiber-matrix interface were observed in both ceramic matrix composites. However, these microcracks were sparse, indicating that both the neat and crosslinked PCS resins were able to infiltrate deep into each ceramic matrix composite during both vacuum bagging and PIP densification because of their low viscosities.

EDS maps of both ceramic matrix composites confirmed the presence of silicon, carbon, and oxygen in the matrix, supporting the earlier Raman analysis. The Raman analysis had previously shown peaks associated with SiO₂ and SiOC, and the EDS maps validated this by illustrating the distribution of oxygen exclusively in the matrix. Together, these results support that the oxygen in the PCS backbone remained after densification and crystallization.

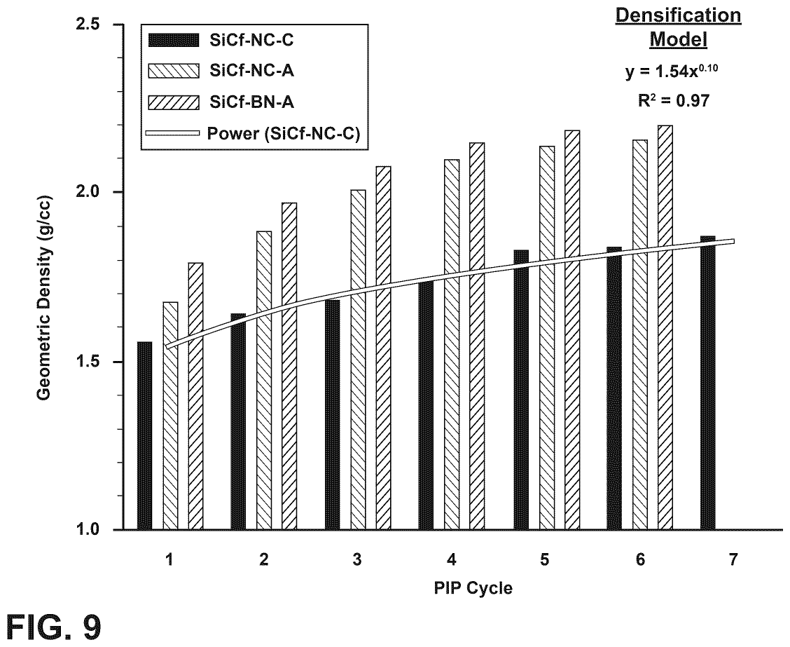

FIG. 9 shows the changes in geometric density of the three SiC—SiC ceramic matrix composites during PIP densification. Similar to the C—SiC composites, the SiC—SiC ceramic matrix composites densified more effectively using the current A-PIP compared to conventional C-PIP. The geometric density of SiCf-NC-A was 8% higher than that of SiCf-NC-C after the first PIP cycle and 19% higher after six cycles. Even after an additional seventh cycle, the geometric density of SiCf-NC-C remained 15% lower than that of SiCf-NC-A. A densification model for SiCf-NC-C predicted that 35 C-PIP cycles would be needed to match the density of SiCf-NC-A obtained after just six A-PIP cycles, highlighting A-PIP's superior efficiency in reducing the number of PIP cycles by 81%. When BN-coated SiC fibers were used with A-PIP, SiCf-BN-A exhibited a 7% higher geometric density than SiCf-NC-A after the first cycle and 2% higher after the seventh, indicating that the BN-coated fibers slightly enhanced densification. According to the densification model for SiCf-NC-C, this ceramic matrix composite would need 43 total conventional C-PIP cycles to reach the same geometric density as SiCf-BN-A after six A-PIP cycles according to the current embodiments, further highlighting A-PIP's efficiency, which reduced the number of cycles by 86%.

After crystallization and machining, a significant internal crack was observed in several SiCf-NC-A tensile bars. This defect was not present in SiCf-NC-C, which used the same fibers but was processed with C-PIP, nor in SiCf-BN-A, which was processed with A-PIP and had BN-coated fibers. This suggested that the combination of non-coated fibers and A-PIP may have contributed to the formation of the defect. The crack in SiCf-NC-A may have propagated due to a combination of factors, including: outgassing from the crosslinked resin, a strong fiber-matrix interface, and residual stresses in the matrix. However, not all SiCf-NC-A samples were affected, and defect-free samples were used to evaluate the material properties.

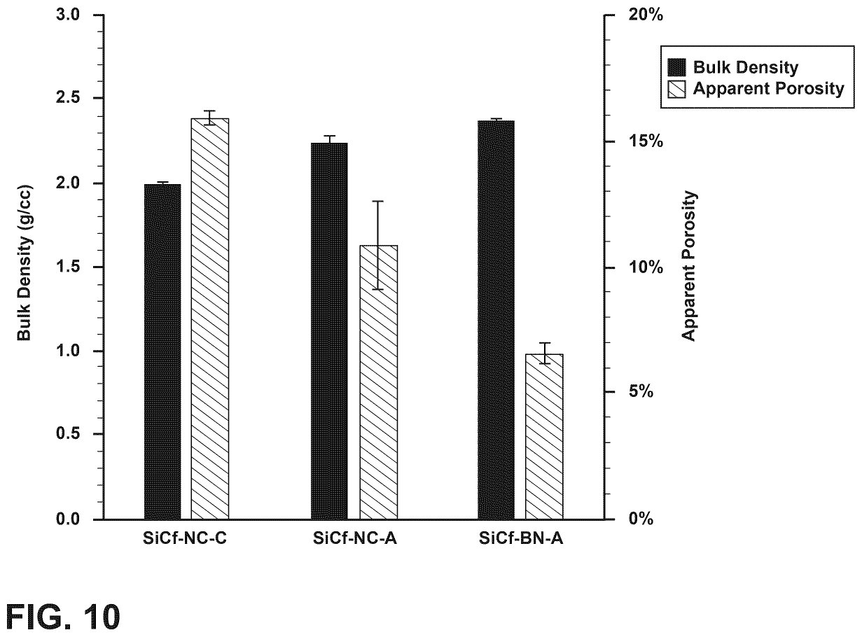

Archimedes density analysis of the crystallized SiCf-SiC composites shown in FIG. 10 confirmed that the current A-PIP produced denser composites with less porosity than conventional C-PIP. SiCf-NC-A was 12% denser (2.24 g/cc bulk density) and 32% less porous (10.9% apparent porosity) than SiCf-NC-C. However, SiCf-NC-A still exhibited 11% porosity. The use of BN-coated fibers in SiCf-BN-A led to a significant reduction in porosity, with an apparent porosity of just 6.5%, a 40% decrease compared to SiCf-NC-A. Additionally, SiCf-BN-A was 6% denser (2.38 g/cc bulk density) than SiCf-NC-A, consistent with densification data. A two-tailed t-test confirmed that the improvement in bulk density due to BN-coated fibers was statistically significant (t-score <0.01). In summary, utilizing BN-coated SiC fibers and the current embodiments of A-PIP resulted in SiC—SiC ceramic matrix composites that were 19% denser and 59% less porous, while reducing the number of cycles by 86%, compared to using non-coated fibers and conventional C-PIP.

The results from the Archimedes density analysis were supported by cross-sectional images of the ceramic matrix composites. SiCf-NC-C clearly showed that conventional C-PIP processing produced a much more porous ceramic matrix composite compared to the current A-PIP. SiCf-NC-C had large voids between the fiber plies and tows due to the low yield of C-PIP. In contrast, SiCf-NC-A showed only small shrinkage cracks. Comparing SiCf-NC-A and SiCf-BN-A revealed a noticeable difference in ply compaction. SiCf-NC-A had large matrix-rich regions between the fiber tows, whereas SiCf-BN-A had fewer matrix-rich areas, and the fibers were tightly compacted. This tighter compaction in SiCf-BN-A, achieved through desizing the Hi-Nicalon™ plies and CVD coating them, contributed to a higher fiber volume fraction and bulk density.

SEM imaging provided more detailed views of the microstructures in each SiC—SiC ceramic matrix composite. SiCf-NC-C had large matrix voids and numerous shrinkage cracks. Similar to the C—SiC composites, the cracks did not penetrate through any of the fibers and the lack of fiber coating resulted in a strong fiber-matrix bonding. In SiCf-NC-A, large matrix regions were found between the plies. These regions contained smaller matrix voids to those found in SiCf-NC-C, but shrinkage cracks were large due to the abundance of matrix material. The cracks propagated through the matrix and around the fibers, avoiding fiber damage. In contrast, SiCf-BN-A showed more compacted fiber plies, leading to fewer matrix voids and smaller shrinkage cracks compared to SiCf-NC-A. While shrinkage cracks avoided the fibers, one crack initiated at the fiber-matrix interface was redirected around multiple fibers, a behavior not observed in the other ceramic matrix composites. The EDS maps of the SiC—SiC ceramic matrix composites showed that, similar to the C—SiC ceramic matrix composites, the matrix of the SiC—SiC ceramic matrix composites contained carbon, oxygen, and silicon. These results confirmed that the PCS systems converted to a combination of SiC, SiO₂, and SiOC.

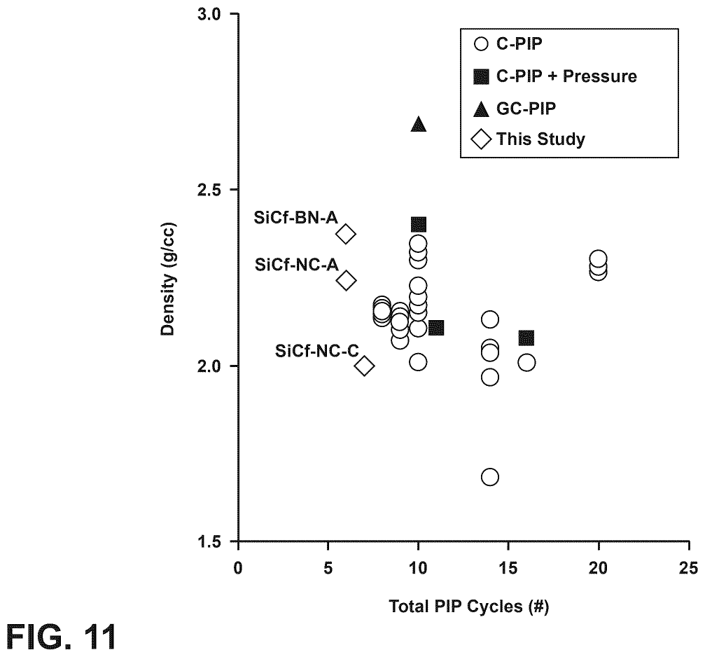

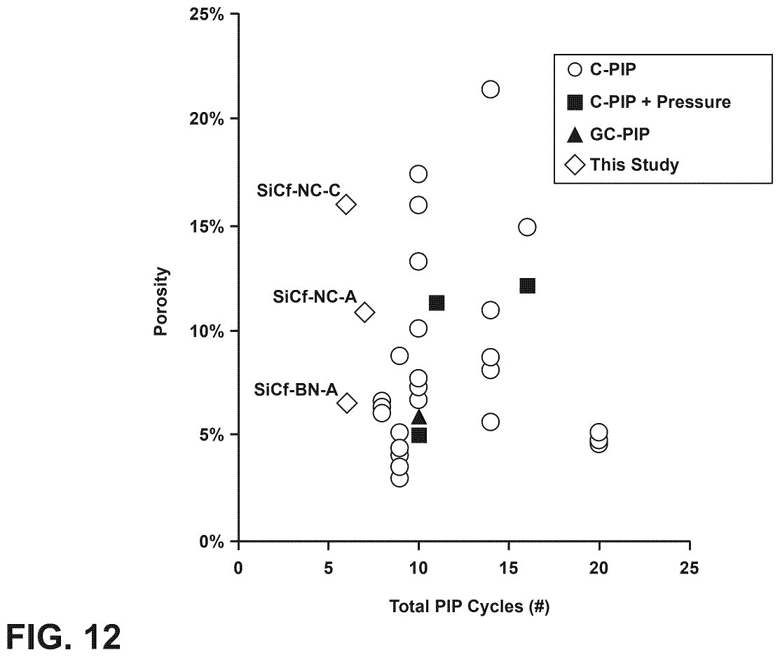

To thoroughly assess the effectiveness of A-PIP, the density and porosity of SiCf-NC-C, SiCf-NC-A, and SiCf-BN-A were compared to SiC—SiC composites reported in literature as shown in FIGS. 11 and 12. The literature values were categorized into three PIP-based methods: PIP performed with preceramic polymer at ambient pressure or vacuum (C-PIP), PIP performed with preceramic polymer in a pressurized vessel (C-PIP+Pressure), and graded concentration polymer infiltration and pyrolysis (GC-PIP). Despite undergoing fewer densification cycles than most reported SiC—SiC composites, both SiCf-NC-A and SiCf-BN-A achieved higher densities than the majority of the SiC—SiC composites, despite the presence of oxygen in the matrix. In particular, SiCf-BN-A exhibited a higher density than all SiC—SiC composites processed with C-PIP, and only the composite densified via GC-PIP reported a significantly higher density. Furthermore, while some SiC—SiC composites reached densities of 2.35-2.4 g/cc, comparable to the density of SiCf-BN-A at 2.38 g/cc, SiCf-BN-A required 40% fewer PIP cycles to achieve this density owing to the high efficiency of A-PIP. In terms of porosity, SiCf-BN-A had a porosity of 6.5%, which was similar to the values reported for composites that underwent 8-10 C-PIP cycles (6.2-6.7%) and the composite processed with 10 GC-PIP cycles (5.9%). These findings demonstrate that the current embodiments of the A-PIP method can produce SiC—SiC composites with densities and porosity comparable to literature values, while requiring fewer PIP cycles.

Tensile specimens were machined into 110 mm×6 mm×3 mm bars from each ceramic matrix composite. To better grip the coupons during testing, 30 mm long tabs were made by attaching 60 grit sandpaper with epoxy to both ends of the coupon. Testing was performed in a custom built 11 kip servo-hydraulic MTS tensile test machine equipped with Advantage Wedge Grips and a 0.2 inch MTS extensometer and followed the ASTM C1275-18 standard. Tension was applied to the coupons in a face-loaded configuration using a constant crosshead displacement rate of 0.005 inch/s until complete fracture. A TESCAN MIRA3 XMH Schottky FE-SEM was used to collect images of coupon fracture surfaces following testing. SEM images were collected at 15 kV, 14 mA, and a spot size of 15 nm in secondary electron mode.

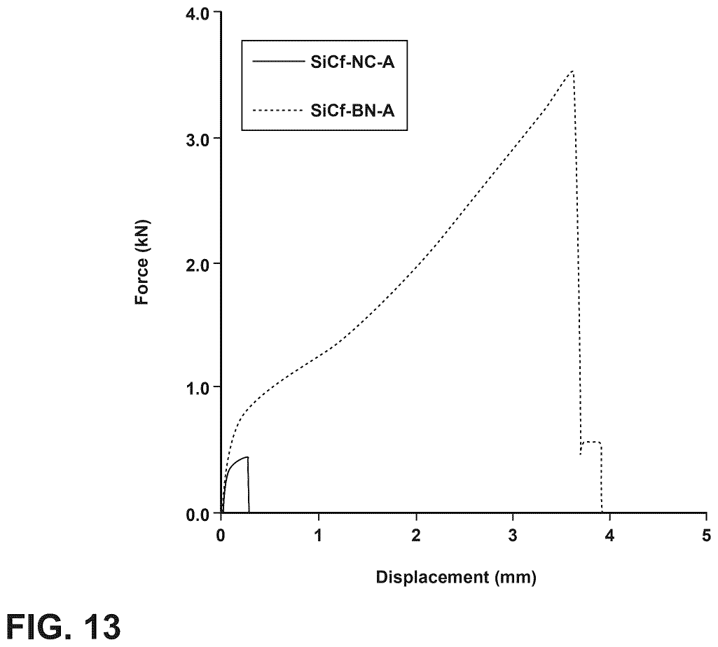

FIG. 13 shows the representative force-displacement curves of SiCf-NC-A and SiCf-BN-A. A clear distinction was observed when switching from non-coated SiC fibers to BN-coated ones. SiCf-NC-A exhibited tensile failure typical of ceramic monoliths, with a linear elastic behavior followed by a brief reduction in stiffness before catastrophically failing under minimal load and deformation. In contrast, SiCf-BN-A, which utilized BN-coated fibers, demonstrated extensive deformation, indicating crack deflection at the weak fiber-matrix interfaces and retention of the high strength of the SiC fibers. As a result, SiCf-BN-A withstood significantly more deformation and load compared to SiCf-NC-A. Even after initial failure, SiCf-BN-A continued to bear some load before ultimately failing, suggesting that fiber pullout occurred. Although SiCf-NC-C was not tested, it was expected to perform even worse than SiCf-NC-A due to its higher porosity. The SEM images corroborate the tensile curve observations. The fracture surface of SiCf-NC-A showed no signs of fiber pullout, with a planar surface indicative of a strong fiber-matrix bond. In contrast, SiCf-BN-A exhibited significant fiber pullout across its fracture surfaces, confirming the fiber pullout behavior observed in the load-displacement curve.

The tensile properties of SiCf-NC-A and SiCf-BN-A listed in Table 2 below more evidently reveal that A-PIP alone does not produce a strong SiC—SiC ceramic matrix composite. While A-PIP effectively reduced porosity and enhanced CMC density compared to C-PIP, the absence of a fiber coating resulted in significantly lackluster tensile properties. In contrast, SiCf-BN-A, which utilized BN-coated SiC fibers, had significantly superior tensile properties. The ultimate tensile strength (UTS), tensile modulus, and strain at UTS were 1172%, 49%, and 771% higher, respectively, compared to SiCf-NC-A. These results clearly indicate that while A-PIP is crucial for improving the density and porosity of SiC ceramic matrix composites, coating the fibers elevates the tensile properties and fracture toughness of SiC ceramic matrix composites.

TABLE 2
Tensile properties of SiCf-NC-A and SiCf-BN-A

| | Bulk Density | Apparent Porosity | UTS | Tensile Modulus | Strain at UTS |
|---|---|---|---|---|---|
| ID | (g/cc) | (%) | (MPa) | (GPa) | (%) |
| SiCf-NC-A | 2.24 ± 0.04 | 10.9 ± 1.8 | 10.55 ± 6.30 | 83.42 ± 31.94 | 0.011 ± 0.005 |
| SiCf-BN-A | 2.38 ± 0.01 | 6.5 ± 0.4 | 134.10 ± 25.27 | 123.89 ± 10.45 | 0.114 ± 0.021 |

A Netzsch LFA457 (Netasch, Selb, Germany) was used to measure the thermal diffusivity and specific heat of the ceramic matrix composites. Samples measuring Ø12.7 mm×2 mm and Ø6 mm×2 mm were used during thermal diffusivity and specific heat measurements, respectively. The samples were coated in graphite then tested in 100° C. intervals to 900° C. Five measurements were taken at each temperature interval during the thermal diffusivity test and one measurement during the specific heat test. To ensure accurate results, two samples were analyzed for each ceramic matrix composite.

After testing, thermal conductivity (k) at each temperature was calculated using Equation 3:

$$k = α \cdot BD \cdot {c}_{p} \qquad ( 3 )$$

where α is thermal diffusivity (mm²/s), BD is Archimedes density (g/cc), and cp is specific heat (J/g·K).

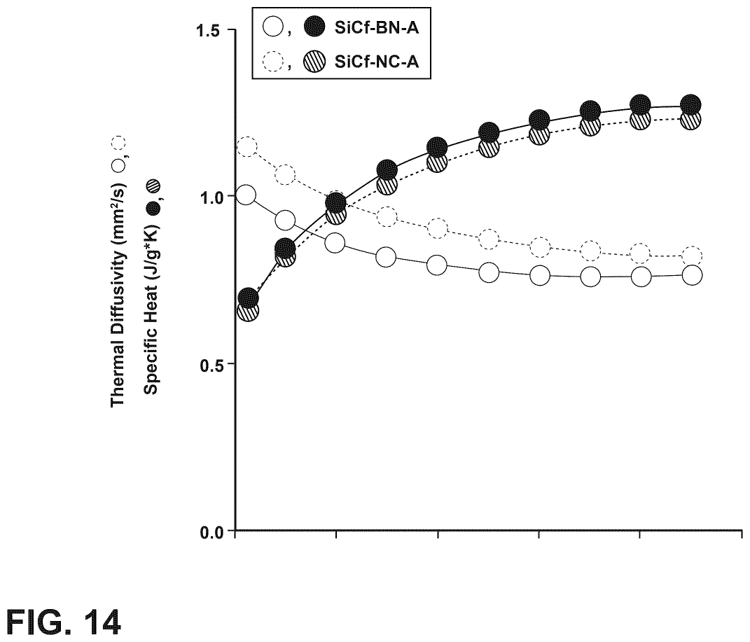

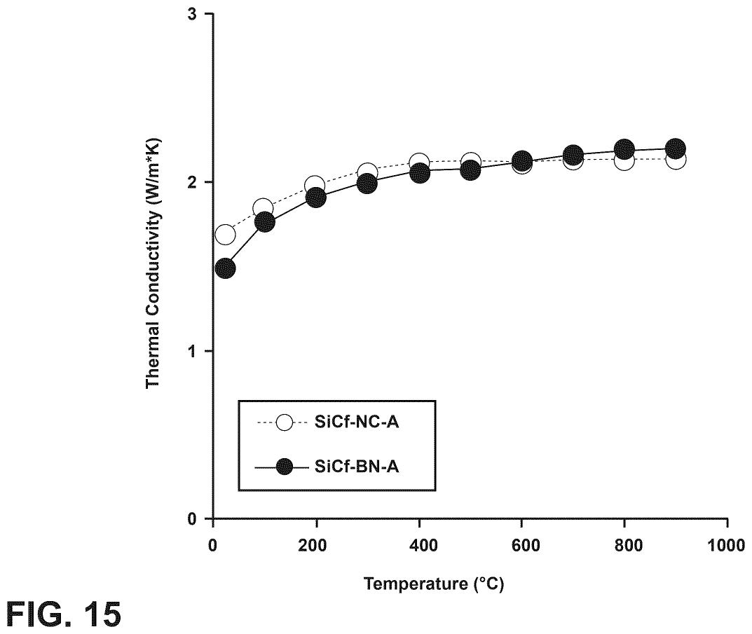

When analyzing the thermal properties of SiCf-NC-A and SiCf-BN-A, their behavior was similar. Slight differences in thermal diffusivity and specific heat were observed as shown in FIG. 14, likely due the difference in porosity between the two ceramic matrix composites. However, their calculated thermal conductivities exhibited comparable trends from room temperature (RT) to 900° C. as shown in FIG. 15. SiCf-NC-A and SiCf-BN-A had thermal conductivities of 1.5-1.7 W/m·K at RT, which slightly increased to 2.20-2.14 W/m·K at 900° C. Although these thermal conductivities are significantly lower than those of state-of-the-art SiC—SiC ceramic matrix composites (70 W/m·K at RT and 35 W/m·K at 1000° C.), this behavior is consistent with previous studies of SiC—SiC ceramic matrix composites. The lower thermal conductivity in these ceramic matrix composites was attributed to the inherent low thermal conductivity of the Hi-Nicalon™ fibers and the porosity within the ceramic matrix composites. Therefore, while A-PIP effectively enhanced densification, it did not overcome the low thermal properties of Hi-Nicalon™ fibers in achieving state-of-the-art thermal conductivity in SiC—SiC composites.

As mentioned above, an additional SiC—SiC composite, SiCf-BN-A+, was fabricated with 17 plies of boron nitride (BN) coated Hi-Nicalon™ that were prepregged with crosslinked polycarbosiloxane (PCS) loaded with 10 wt. % B—SiC powder (US Research Nanomaterials, Inc, Houston, TX) with the intent to improve ceramic yield after the initial pyrolysis. SiCf-BN-A+ underwent seven A-PIP cycles before being crystallized.

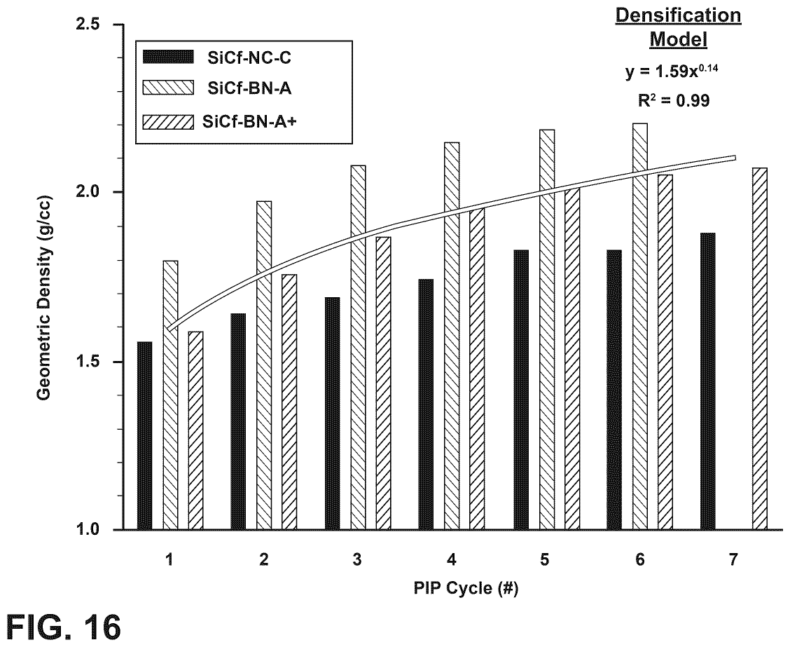

FIG. 16 shows the densification of SiCf-BN-A+ compared to SiCf-NC-C and SiCf-BN-A. Although SiCf-BN-A+ was prepregged with crosslinked PCS resin containing 10 vol. % SiC powder, its geometric density was only 1.7% higher than SiCf-NC-C and 12% lower than SiCf-BN-A after the first PIP cycle. The density of SiCf-BN-A+ increased rapidly with successive A-PIP cycles, but it only reached a geometric density of 2.07 g/cc after seven cycles, 6% lower than SiCf-BN-A after just six cycles. The densification model predicted that SiCf-BN-A+ would require an additional three A-PIP cycles (ten in total) to achieve the same geometric density as SiCf-BN-A after six cycles, indicating that the addition of SiC powder during prepregging reduced the efficiency of A-PIP by 67%.

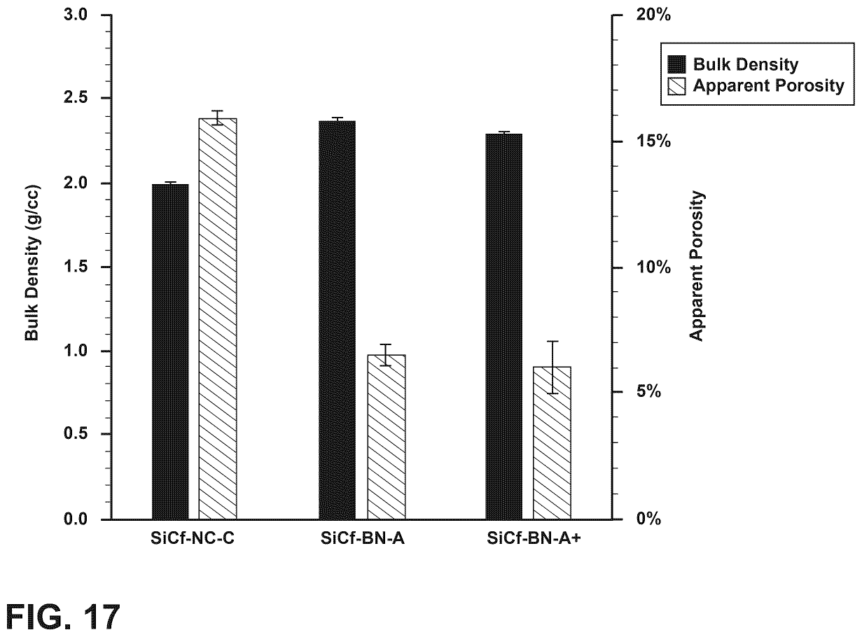

Similar to the observations made during densification, SiCf-BN-A+ was 4% less dense than SiCf-BN-A (t-score <0.01), but had a comparable density to SiCf-NC-A (t-score >>0.05) after an additional A-PIP cycle and crystallization as shown in FIG. 17. Additional A-PIP cycles would be needed for SiCf-BN-A+ to have a similar density as SiCf-SiC-3. Furthermore, SiCf-BN-A+ had a similar porosity to SiCf-BN-A (t-score >>0.05), indicating that prepregging coated fibers with crosslinked PCS loaded with SiC powder negatively impacts density without affecting porosity.

The cross-sectional images of SiCf-BN-A and SiCf-BN-A+ revealed that ply compaction was reduced in SiCf-BN-A+, where large matrix-rich regions were more prevalent throughout its microstructure compared to SiCf-BN-A. This was due to the SiC powder increasing the viscosity of the crosslinked PCS, resulting in thicker ply coatings and more space in-between the plies. The abundance of matrix-rich regions led to a lower fiber volume fraction and, consequently, a lower bulk density compared to SiCf-BN-A.

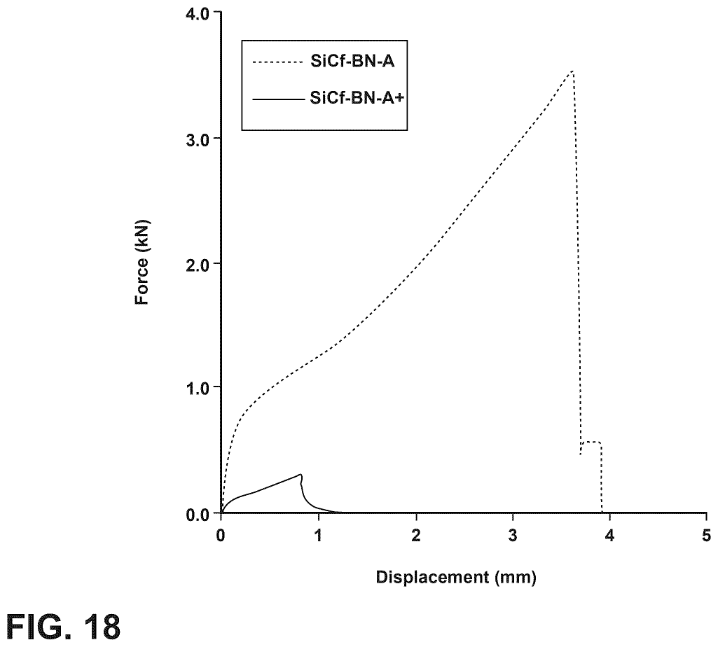

FIG. 18 shows representative tensile force-displacement curves of SiCf-BN-A and SiCf-BN-A+. SiCf-BN-A+ failed under significantly less load and displacement than SiCf-BN-A due to the abundance of matrix-rich areas in its microstructure. These regions both lowered the fiber volume fraction of the ceramic matrix composite and acted as stress concentrations due to their brittleness, causing cracks to propagate quickly throughout the ceramic matrix composite and failing prematurely. Although SiCf-BN-A+ failed under insignificant load, the ceramic matrix composite did undergo fiber pullout.

Table 3 compares the tensile properties of SiCf-BN-A and SiCf-BN-A+. As expected, SiCf-BN-A had superior ultimate tensile strength (UTS) and tensile modulus compared to SiCf-BN-A+. However, SiCf-BN-A+ had a strain at UTS 7% higher than SiC—BN-A. This could be due to the presence of SiC powder within the matrix of SiCf-BN-A+.

TABLE 3
Material and tensile properties of SiCf-BN-A and SiCf-BN-A+

| | Bulk Density | Apparent Porosity | UTS | Tensile Modulus | Strain at UTS |
|---|---|---|---|---|---|
| ID | (g/cc) | (%) | (MPa) | (GPa) | (%) |
| SiCf-BN-A | 2.38 ± 0.01 | 6.5 ± 0.4 | 134.10 ± 25.27 | 123.89 ± 10.45 | 0.114 ± 0.021 |
| SiCf-BN-A+ | 2.29 ± 0.03 | 6.1 ± 1.0 | 20.44 ± 3.09 | 18.63 ± 2.07 | 0.122 ± 0.027 |

In summary, the results confirmed that crosslinking and catalyzing the PCS resin improved the mass yield from 76% to 88%. Raman spectroscopy and EDS analysis revealed that both neat and crosslinked PCS resins produced a mixture of SiC, SiO₂, and SiOC, indicating that oxygen in the PCS backbone remained after pyrolysis and crystallization. Rheology tests highlighted an important trade off with crosslinking PCS resin: while adding crosslinkers and catalysts does not significantly affect its viscosity in the short term, it severely limits the resin's shelf life (1.5-2 hours) and renders it unusable after curing.

Significantly, the current embodiments of A-PIP produced denser and less porous C—SiC and SiC—SiC composites in fewer densification cycles compared to conventional PIP (C-PIP). A-PIP increased bulk density by 17% and reduced apparent porosity by 78% after 7 PIP cycles. Most notably, A-PIP reduced the number of cycles by 79% due to its high yield. Similarly, in SiC—SiC composites, A-PIP increased bulk density by 19% and reduced apparent porosity by 59% after 7 PIP cycles, while reducing the total number of cycles by 86%. These results highlight the effectiveness and versatility of A-PIP in reducing the densification process of two different ceramic matrix composites.

The impact of BN-coated fibers on SiC—SiC densification and material properties was also examined. Using BN-coated fibers, along with A-PIP, further increased density and reduced porosity by 6% and 40%, respectively, compared to non-coated fibers. Microstructure analysis showed that BN-coated fibers compacted more effectively than non-coated fibers, resulting in higher fiber loading and lower porosity.

BN-coated SiC fibers also significantly improved the tensile strength and toughness of SiC—SiC ceramic matrix composites. Coated fibers increased ultimate tensile strength (UTS) by 1172%, tensile modulus by 49%, and strain at UTS by 771% due to fiber pullout. This underscores the importance of using strong interfaces to achieve high-strength SiC—SiC composites. However, the thermal conductivities of the SiC—SiC ceramic matrix composites (1.5-1.7 W/m·K at room temperature and 2.20-2.14 W/m·K at 900° C.) were lower compared to state-of-the-art values (70 W/m·K at room temperature and 35 W/m·K at 1000° C.), which was attributed to the low thermal conductivity of Hi-Nicalon™ fibers.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of manufacturing a ceramic composite, the method comprising:
prepregging a plurality of porous fiber cloths, a powder compact, a combination of porous fiber cloths and powder compact, or an additively-manufactured matrix and fibers, with a preceramic polymer composition to form a composite body;
curing the composite body followed by pyrolyzing the cured composite body to obtain a ceramic composite body;
densifying the ceramic composite body by sequentially performing a plurality of densification cycles to obtain a densified ceramic composite body, wherein each densification cycle includes in the following order:
submerging the ceramic composite body in the preceramic polymer composition to impregnate the ceramic composite body;
subjecting the impregnated ceramic composite body to a vacuum;
curing the impregnated composite body at a curing temperature; and
pyrolyzing the impregnated composite body at a pyrolyzing temperature;
crystallizing the densified ceramic composite body at a crystallization temperature to obtain a ceramic matrix composite product;
wherein the preceramic polymer composition comprises a preceramic polymer component, a crosslinker, and a catalyst.

2. The method of claim 1, wherein each densification cycle further includes subjecting the impregnated ceramic composite body to pressure while submerging the ceramic composite body in the preceramic polymer composition.

3. The method of claim 1, wherein the preceramic polymer component is one of: i) a polycarbosiloxane; ii) a polysiloxane; iii) a polysilazane; iv) a carbosilane; or v) a combination of two or more of i) through iv).

4. The method of claim 1, wherein the catalyst is a Pt, Sn, Mo, Ti, or Bi-based catalyst.

5. The method of claim 1, wherein the crosslinker is a backbone material having functional groups for addition and/or condensation cure reactions, the backbone material including silicon and oxygen and/or carbon.

6. The method of claim 1, wherein the fiber cloths or powder compacts are a carbon-based material or a ceramic material.

7. The method of claim 6, wherein the fiber cloths are coated with one or more of boron nitride, boron carbonitride, silicon nitride, and pyrolytic carbon (PyC).

8. The method of claim 1, wherein the composite body is formed by laminating the plurality of prepreg fiber plies.

9. The method of claim 1, wherein in the step of prepregging the plurality of fiber cloths or powder compact, the preceramic polymer composition further comprises silicon carbide (SiC) powder.

10. The method of claim 1, wherein the step of densifying the ceramic composite body includes: i) at least five of the densification cycles; ii) from six to ten of the densification cycles; or iii) no more than seven of the densification cycles.

11. The method of claim 1, wherein the ceramic matrix composite product has a matrix including one or more of carbon (C), silicon oxycarbide (SiOC), silicon carbide (SiC), and silicon dioxide (SiO₂), silicon carbonitride (SiCN), silicon oxynitride (SiON), trisilicon tetranitride (Si₃N₄), and boron carbide (B₄C).

12. The method of claim 1, wherein the curing temperature is in a range of from 150 to 300° C.

13. The method of claim 1, wherein the pyrolyzing temperature is in a range of from 700 to 1000° C.

14. The method of claim 1, wherein the crystallization temperature is in a range of from 1000 to 1700° C.

15. A ceramic matrix composite formed by the method of claim 1.
